(19) United States
(12) Patent Application Publication
(10) Pub. No.: US 2024/0010431 A1
(43) Pub. Date: Jan. 11, 2024

(54) AUTOMATED MOBILE ROBOTS FOR AUTOMATED DELIVERY AND ASSISTED DELIVERY

(71) Applicant: Rehrig Pacific Company, Los Angeles, CA (US)

(72) Inventor: Dane Gin Mun Kalinowski, Foothill Ranch, CA (US)

(21) Appl. No.: 18/218,824

(22) Filed: Jul. 6, 2023

Related U.S. Application Data
(60) Provisional application No. 63/358,554, filed on Jul. 6, 2022.

(51) Int. Cl. B65G 1/137; G05D 1/00; G05D 1/02

(52) U.S. Cl. CPC B65G 1/1373; G05D 1/0022; G05D 1/0278; G05D 2201/0216

(57) ABSTRACT

An automated mobile robot for assisted and/or automated delivery between a delivery vehicle and a store may take the form of an automated pallet sled. The automated pallet sled may include a base and tines that can be raised by a lift actuator. A processor and various sensors enable the automated pallet sled to navigate and avoid people and obstacles. In a first implementation, the automated pallet sled retrieves pallets destined for a store at a current location within the delivery vehicle and places them on a liftgate of the delivery vehicle. In a second implementation, the automated pallet sled follows a manual pallet sled operated by the driver. In another implementation, the automated pallet sled brings pallets into the store independently of the driver.

### BACKGROUND

Automated Guided Vehicle (AGV) and Automated Mobile Robot (AMR) technology exists today and is commonly implemented in warehouse-like environments that are well-predictable and controlled. The technology typically relies on fixed landmarks such as lines on the ground, reflectors on pillars or QR codes displayed throughout. This technology would not work in a dynamic, delivery scenario from a truck in a parking lot to multiple stores and coolers.

Delivery in beverage and food service applications (to name a few) is a very labor-intensive job. It is common to transport multiple pallets of over 1000 lb from the trailer, box truck or delivery van into the store, restaurant, etc. Not only is it labor intensive, but it also requires a significant amount of time.

The assignee of the present invention currently provides powered equipment to make the job easier, providing the operator a powered lift and powered drive solution to transport the pallets, but it still requires a hands-on, trained person to operate. In this application companies will typically allocate more labor to the delivery, which may not always be available. This labor typically comes in the form of a ride along helper or an additional vehicle and driver which significantly increases cost.

### SUMMARY

One goal of the present disclosure is to provide assist and automation functionality to complement the driver's capabilities. This may require an AMR/AGV system to be mobile with the delivery vehicle versus the static warehouse setup.

One solution semi- or fully automates either the same or a complementary piece of equipment eliminating the additional hands-on person. In addition to reducing the resource requirement for the delivery, it also reduces the amount of time required onsite by performing the delivery more efficiently so the driver can focus on the critical aspects like check in.

Assisted Delivery

Increased delivery efficiency does not necessarily require a fully automated piece of equipment. In an assisted application the equipment can perform mundane, repetitive and time-intensive tasks while the driver performs additional responsibilities.

As a first example, an AMR, such as an automated pallet sled, could provide the maneuvering and orienting of pallets in the trailer, staging pallets on the lift gate and even operating the lift gate while the driver transports other pallets to/from the store or restaurant.

Additional applications could include automated pallet sled that simply follows the driver. In this case the driver would perform the delivery as per usual, utilizing another piece of equipment to grab a pallet and transport it. The technology-equipped equipment could perform the same picking and lifting of a pallet, either manually or automatically, and simply follow the driver from a safe distance to increase the delivery efficiency. This application may require some driver intervention such as identifying and picking the pallet all the way to defining the delivery transportation path since the equipment will follow.

Full Automated Delivery

The next step beyond assisted delivery is fully automated. In this application the technology-equipped, automated material handling equipment will complete the same tasks as the driver without any intervention. The equipment will automatically identify and pick the pallet, then transport it from the truck/trailer/van to the restaurant or store without any inputs from the driver. The equipment will automatically react to the environment, whether it is obstacles such as speed bumps, curbs or people to complete the delivery.

In some aspects, the techniques described herein relate to a delivery assist system for use inside a delivery vehicle including: at least one support surface for supporting a pallet; a plurality of wheels supporting the at least one support surface; a motor configured to drive at least one of the plurality of wheels; at least one processor; a non-transitory computer readable medium storing instructions which when executed by the at least one processor cause the delivery assist system to: (a) locate a first pallet on the delivery vehicle; (b) lift the first pallet on the at least one support surface; and (c) move the first pallet on the at least one support surface within the delivery vehicle.

In some aspects, the techniques described herein relate to a delivery assist system wherein the instructions, when executed by the at least one processor cause the delivery assist system to, prior to operation a): (d) receive a current location; and (e) based upon the current location, determine that the first pallet should be delivered.

In some aspects, the techniques described herein relate to a delivery assist system further including an rfid reader, wherein the instructions, when executed by the at least one processor cause the delivery assist system to: (f) prior to operation c) read an rfid tag on the first pallet with the rfid reader.

In some aspects, the techniques described herein relate to a delivery assist system wherein the instructions, when executed by the at least one processor cause the delivery assist system to: (g) prior to operation f), read an rfid on a second pallet with the rfid reader; and (h) prior to operation f), based upon the current location, determine that the second pallet should not be delivered.

In some aspects, the techniques described herein relate to a delivery assist system further including a gps receiver for determining the current location, wherein the current location is received in operation d) from the gps receiver.

In some aspects, the techniques described herein relate to a delivery assist system wherein operation c) includes move the first pallet onto a lift gate of the delivery vehicle.

In some aspects, the techniques described herein relate to a delivery assist system wherein the instructions, when executed by the at least one processor cause the delivery assist system to cause the lift gate to move to a lowered position.

In some aspects, the techniques described herein relate to a delivery assist system further including a lift mechanism for raising the at least one support surface relative to the plurality of wheels.

In some aspects, the techniques described herein relate to a delivery assist system wherein the instructions, when executed by the at least one processor cause the delivery assist system to: d) receive a current location; e) read an rfid tag on each of a first plurality of pallets including the first pallet; f) based upon the current location and the rfid tags, determine that the first plurality of pallets should be delivered at the current location; and g) based upon operation f), perform operations a) through c) on each of the first plurality of pallets.

In some aspects, the techniques described herein relate to a delivery assist system including: at least one support surface for supporting a pallet; a plurality of wheels supporting the at least one support surface; a motor configured to drive at least one of the plurality of wheels; at least one processor; a non-transitory computer readable medium storing instructions which when executed by the at least one processor cause the delivery assist system to: a) raise a pallet on the at least one support surface; b) follow a primary delivery sled from a delivery vehicle to a delivery destination; and c) lower the pallet onto a floor or ground at the delivery destination.

In some aspects, the techniques described herein relate to a delivery assist system wherein the delivery destination is outside of a store.

In some aspects, the techniques described herein relate to a delivery assist system further including a camera, wherein operation b) includes use the camera to follow the primary delivery sled.

In some aspects, the techniques described herein relate to a delivery assist system including: at least one support surface for supporting a pallet; a plurality of wheels supporting the at least one support surface; a motor configured to drive at least one of the plurality of wheels; at least one processor; a non-transitory computer readable medium storing instructions which when executed by the at least one processor cause the delivery assist system to: a) place a pallet from a delivery vehicle onto the at least one support surface; and b) move the pallet on the at least one support surface from the delivery vehicle to a delivery destination.

In some aspects, the techniques described herein relate to a delivery assist system wherein the delivery destination is outside a door of a store.

In some aspects, the techniques described herein relate to a delivery assist system wherein the delivery destination is inside a store.

In some aspects, the techniques described herein relate to a delivery assist system wherein the instructions, when executed by the at least one processor cause the delivery assist system to: c) deliver the pallet to the delivery destination; d) return to the delivery vehicle without the pallet; and e) repeat operations a) through d) for each of a plurality of pallets.

In some aspects, the techniques described herein relate to a delivery assist system wherein operation a) further includes: lift the pallet from a liftgate of the delivery vehicle.

In some aspects, the techniques described herein relate to a computer-implemented method for assisting deliveries including: a) locating a first pallet among a plurality of pallets on a delivery vehicle; b) receiving a current location; c) determining that the first pallet should be delivered at the current location; and d) moving the first pallet via a computer controlling an automated pallet sled to a liftgate of the delivery vehicle.

In some aspects, the techniques described herein relate to a computer-implemented method further including: e) prior to step d), lifting the first pallet on at least one support surface of the automated pallet sled; and f) during step d), controlling at least one motor driving the automated pallet sled.

In some aspects, the techniques described herein relate to a computer-implemented method for assisting deliveries including: a) lifting a first pallet on a support surfaced of an automated pallet sled; and b) at least one processor on the automated pallet sled controlling the automated pallet sled to follow a primary pallet sled from a delivery vehicle to a delivery destination.

### BRIEF DESCRIPTION OF THE DRAWINGS

FIG. 1 shows an automated pallet sled according to an example embodiment.

FIG. 2 is a perspective view of the underside of the automated pallet sled of FIG. 1.

FIG. 3 shows the automated pallet sled with the tines adjusted to be spaced further apart.

FIG. 4 is an example schematic of the automated pallet sled of FIG. 1.

FIG. 5 is a rear perspective view of the automated pallet sled of FIG. 1.

FIG. 6 shows a manual pallet sled that could be used with the automated pallet sled of FIG. 1.

FIG. 7 is a plan view of an assisted delivery system utilizing the automated pallet sled of FIG. 1 and the manual pallet sled of FIG. 6.

FIG. 8 illustrates one step in a first method of operating the assisted delivery system of FIG. 6.

FIG. 9 is another view of the step of operating the assisted delivery system according to the method shown in FIG. 8.

FIG. 10 illustrates another step in operating the assisted delivery system according to the method of FIG. 8.

FIG. 11 illustrates one step in another method of operating the assisted delivery system of FIG. 6.

FIG. 12 illustrates another step in the method of FIG. 11.

FIG. 13 illustrates a third step in the method of FIG. 11.

FIG. 14 illustrates a fourth step in the method of FIG. 11.

FIG. 15 illustrates one step in another method of using the assisted delivery system of FIG. 6.

FIG. 16 illustrates another step in the method of FIG. 15.

### DETAILED DESCRIPTION

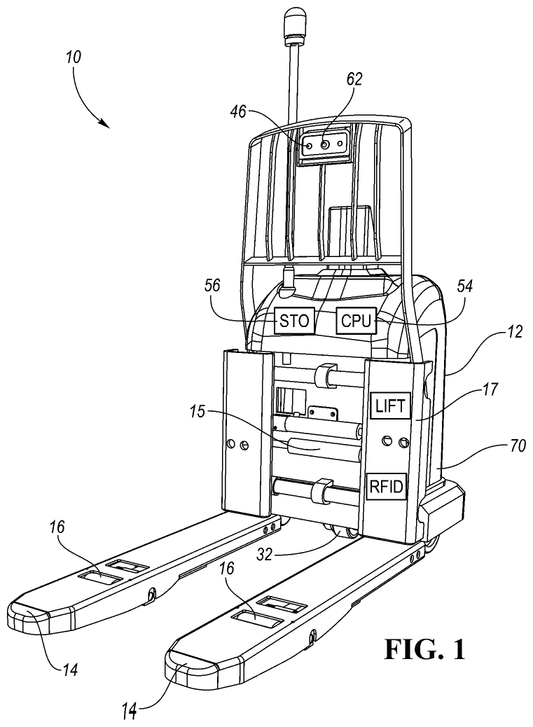

An automated pallet sled 10 is shown in FIG. 1. The automated pallet sled 10 includes a base 12 connected to a pair of fork tines 14, each providing at least one support surface for supporting a pallet. A lift actuator 17 in the base 12 can raise and lower the fork tines in a known manner, by leveraging the load wheels 16 supporting the tines 14. The lift actuator 17 can include known actuators such as hydraulics, pneumatics, electric motors, or via a manual actuator. The base 12 can also move the tines toward and away from one another with the tine spacing actuators 15, which could be hydraulics, pneumatics, electric motors driving a ball screw or a threaded rod, or via a manual actuator.

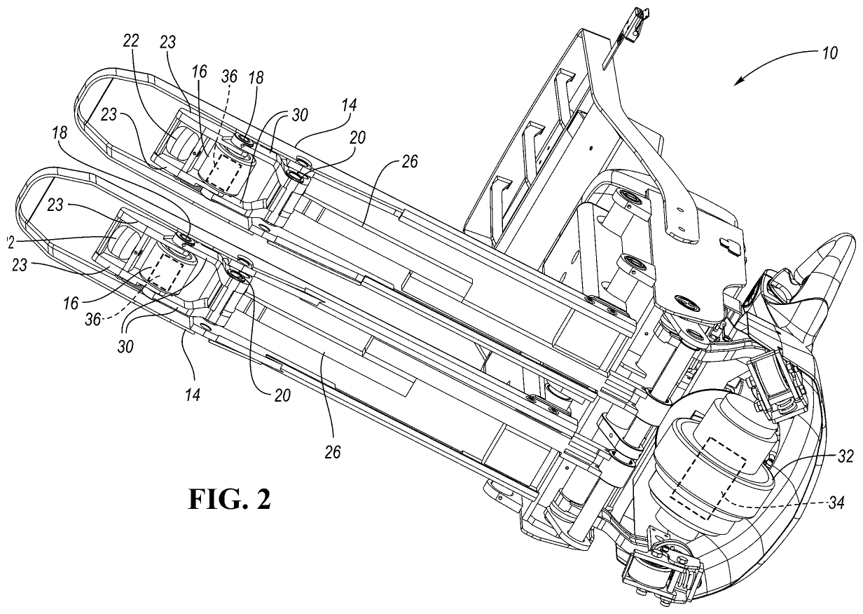

The automated pallet sled 10 may include a mechanism for facilitating the adjustment of the tine spacing without dragging the load wheels 16. FIG. 2 is a perspective view of the underside of the automated pallet sled 10 of FIG. 1. Each tine 14 includes a load wheel 16 which is rotatable on an axis 18 perpendicular to the long axis of the tine 14. The load wheel axis 18 is mounted at the end of a pair of arms 30 which are pivotable about an axis 20 fixed to the tine 14. The axis 20 is spaced rearwardly of the axis 18, and also perpendicular to the long axis of the tine 14. A side wheel 22 is mounted to arms 23 extending forwardly of the load wheel 16 and is oriented in a direction such that its axis is transverse to the load wheel axis 18. The arms 23 are pivotable about the axis 18 (but could alternatively pivot about an axis parallel to that load wheel axis 18) in a vertical plane parallel to the long axis of the tine 14.

As explained below, the side wheel 22 can facilitate lateral motion of the tine 14. A push rod 26 within each tine 14 is actuated by the lift actuator 17 to pivot the arms 30 to deploy and retract the load wheels 16 in a known manner.

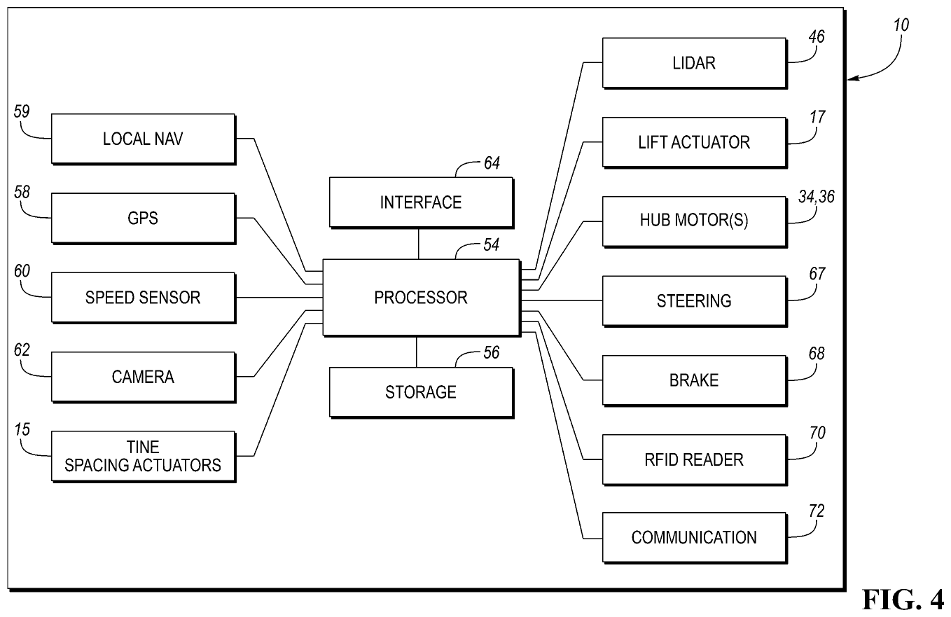

The automated pallet sled 10 also includes a rear wheel 32 supporting the base 12. In this configuration, the rear wheel 32 is pivotable about a vertical axis by a steering motor 67 (FIG. 4). A hub motor 34 within the rear wheel is configured to drive the rear wheel 32 rotatably to drive the pallet sled 10. There are also hub motors 36 within each of the load wheels 16 for driving the automated pallet sled 10. Alternatively, the hub motors 34, 36 is not in both the load wheels 16 and the rear wheel 32. A removable battery pack in the base 12 powers the raising and lowering of the tines 14, the hub motors, at least one motor or other actuator for steering the rear wheel 32, and electronics for controlling the automated pallet sled 10.

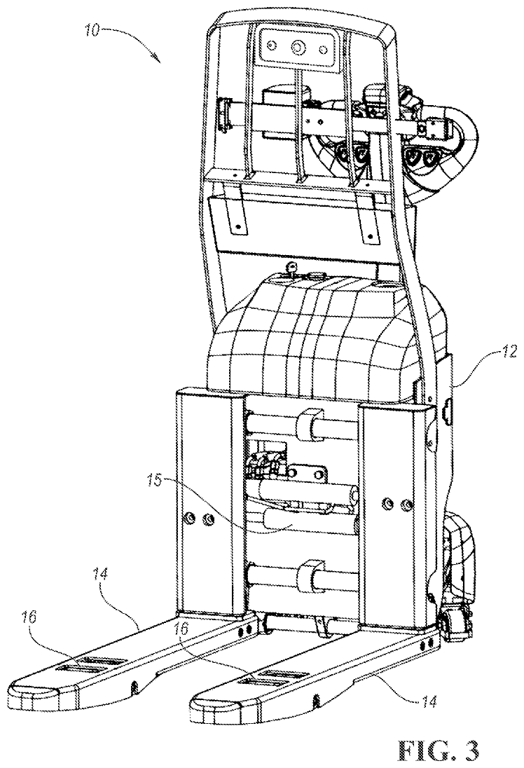

In FIGS. 1 and 2, the tines 14 of the automated pallet sled 10 are spaced closer to one another. In FIG. 3, the tines 14 are spaced further apart. The actuators 15 for moving the tines 14 toward and away from each other are shown on the base 12. As is explained in previous patents assigned to the assignee of the present invention, the side wheels 22 permit the tines 14 to be moved toward and away from each other without dragging the load wheels 16 parallel to their axes 18, which could cause damage to the load wheels 16 and/or the floor.

FIG. 4 shows one possible schematic of the automated mobile pallet sled 10. Referring to FIGS. 1 and 4, the processor 54 may be mounted in the base 12. The processor 54 is connected to electronic storage 56, which includes a nontransitory computer readable medium storing computer instructions which when executed by the processor 54 causes the automated mobile pallet sled 10 to perform the functions described herein. Unless otherwise specified, the “processor” 54 is at least one processor and could include a plurality of processors, or plurality of cores, or a plurality of computers of different types at different locations, some onboard and some remote from the automated mobile pallet sled 10.

The processor 54 receives inputs from a GPS receiver 58. The GPS receiver 58 is shown onboard the automated pallet sled 10 but it could be on the delivery vehicle, on a user's mobile device, or otherwise nearby the automated pallet sled 10. “GPS” herein refers generically to any global navigation satellite system.

One or more local navigation sensors 59 may provide signals to the processor 54. The one or more local navigation sensors 59 provide information regarding location and orientation within the delivery vehicle, such as locating fiducials located within the delivery vehicle, either via at least one camera, NFC transceivers, accelerometers, gyros, etc.

At least one speed sensor 60 may be mounted to one of the load wheels 16 and/or the rear wheel 32. A camera 62 may be mounted to one of the tines 14 or to the base 12, or both. The camera 62 provides continuous live video from the camera 62 to the processor 54. The processor 54 receives signals from a user interface 64, which may include one or more of: a touchscreen, microphone, button, switch, keyboard, trackpad, mouse, etc.

The processor 54 sends control signals to the lift actuator 17 in the manner described herein. The processor 54 also sends control signals to the hub motors 34, 36 in the load wheels 16 and the rear wheel 32. The processor 54 controls a steering motor 67 which pivots the rear wheel 32 about a vertical axis to steer the automated mobile pallet sled 10. The processor 54 also controls a brake 68 (if provided) on one or more of the load wheels 16 and rear wheel 32. The processor 54 controls the tine-spacing actuators 15.

The processor 54 is connected to at least one RFID reader 70 for reading rfid tags on pallets. The at least one RFID reader 70 may be mounted at an outer end of one of the tines 14 and/or on the base 12.

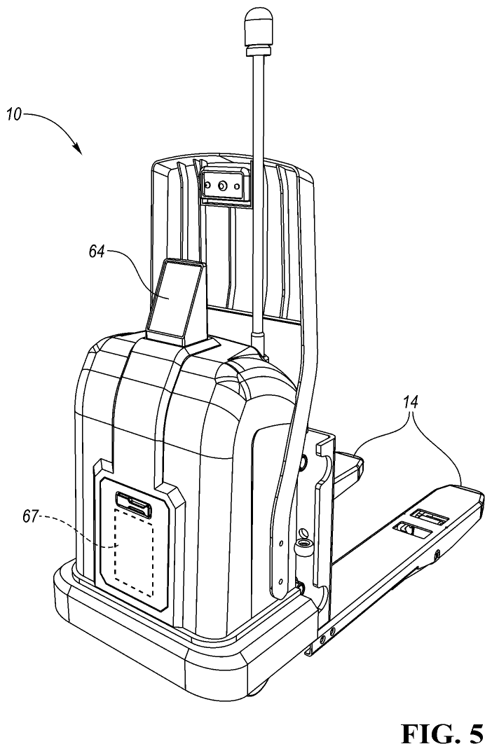

The processor 54 is connected to a wireless communication circuit 72 which provides one or more of: cell data, wifi, Bluetooth, etc. A rangefinder 46 may be provided to provide signals to the processor 54 to assist the processor 54 with navigation, obstacle avoidance, as well as finding and engaging pallets. The rangefinder 46 may be LIDAR, radar, a 3D camera or a laser or other suitable sensor. FIG. 5 is a rear perspective view of the automated pallet sled 10, showing the user interface 64 and the steering motor 67.

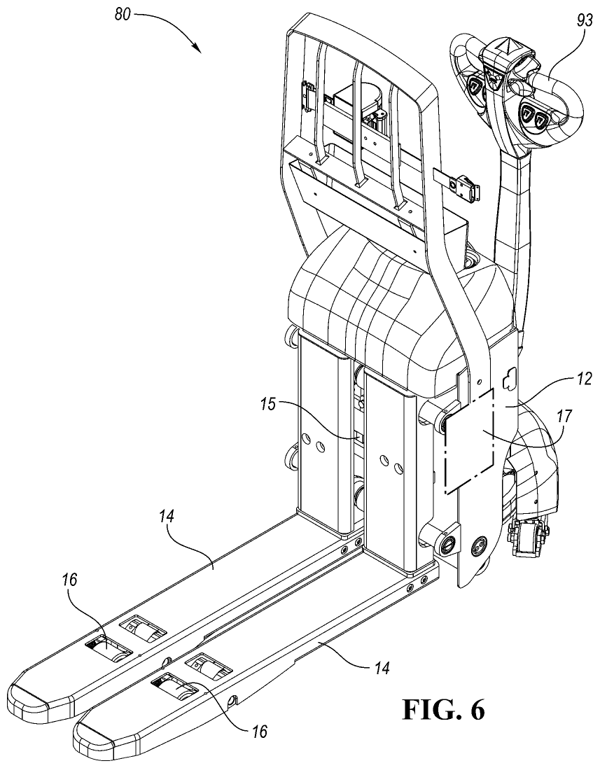

FIG. 6 shows a manual pallet sled 80 which is identical to the automated pallet sled 10 of FIG. 1 except as shown in FIG. 6 or described below. The manual pallet sled 80 includes the base 12, the tines 14, the load wheels 16, the rear wheel 32 (not visible), the lift actuator 17, and the tine spacing actuators. Alternatively, the tines 14 of the automated pallet sled 10 may be shorter, such that they are only capable of carrying one half-pallet at a time, while the tines 14 of the manual pallet sled 80 are longer and capable of carrying two or more half-pallets at a time.

The manual pallet sled 80 does not need the steering motor 67 and some of the sensors for facilitating automated navigation and obstacle avoidance as does the automated pallet sled 10; however, they could also be used in the manual pallet sled 80 under the control of the user. The manual pallet sled 80 shown includes a tiller arm 93 for rotating the rear wheel about a vertical axis to steer the manual pallet sled 80. The tiller arm 93 also includes controls (e.g. buttons and switches) to permit the user to control the hub motors, lift actuator 17, and tine spacing actuators 15. Alternatively, fixed upright handles could be provided on the base 12.

The automated pallet sled 10 and the manual pallet sled 80 can be used together in several different ways, as explained below.

Assisted Delivery

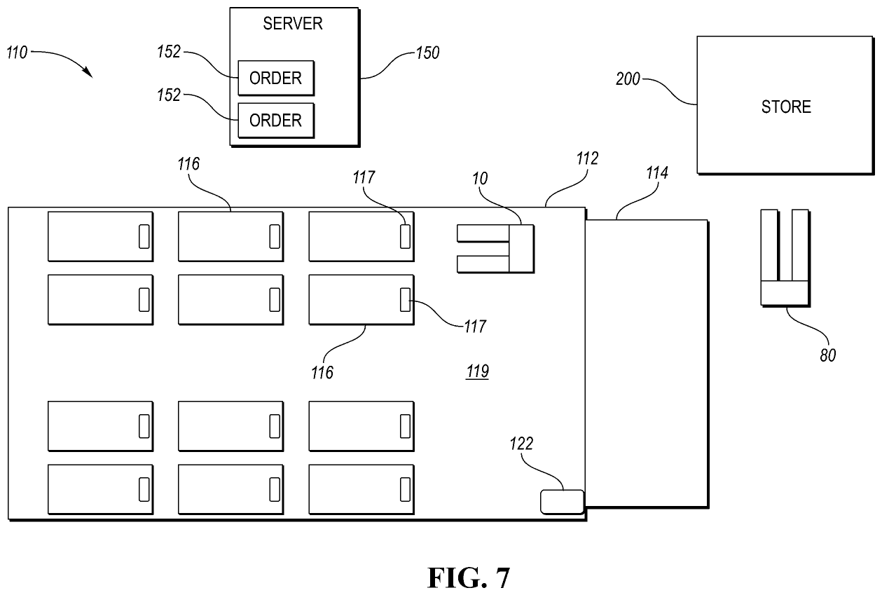

A top view schematic of an assisted delivery system 110 is shown in FIG. 7 implemented in this example with a delivery vehicle 112 (e.g. a truck) having a liftgate 114 controlled by a liftgate controller 122. A plurality of pallets 116, each loaded with goods such as packages 118 of beverage containers, are loaded in a storage area 119 of the delivery vehicle 112 accessible via the liftgate 114. Each of the pallets 116 has an RFID tag 117 (or NFC chip or barcode or QR code or any unique identifier). Often five or six pallets are destined for a single store. In the example shown, the pallets 116 are “half pallets,” i.e. in the range of 118″ to 124″ by 136″ to 148″; however, the inventions described herein could be used with full-sized pallets as well.

A server 150 includes at least one processor and electronic storage containing a plurality of orders 152. Each of the orders 152 corresponds to an order for a different one of a plurality of stores, including store 200. A “store” can be any destination for the plurality of loaded pallets 116, including any type of retail store, restaurant, convenience store, grocery store, big box store, entertainment facility, etc.

Each of the orders 152 also indicates which of the plurality of pallets 116 in the delivery vehicle 112 should be delivered to each store, including store 200. At least one, and more often more than one pallet 116 is associated with each order and intended to be delivered to each store. Often four to seven or more pallets 116 are associated with each order. The electronic storage includes a nontransitory computer readable medium also storing instructions which when executed by the at least one processor cause the server 150 to perform the functions described herein. The server 150 communicates wirelessly (e.g. via the internal with the automated pallet sled 10 and the 110.

In this example, the automated pallet sled 10 is dedicated to the delivery vehicle 112, i.e. it remains in the delivery vehicle 112.

In operation, the delivery vehicle 112 is loaded with a plurality of loaded pallets 116, each intended for one of a plurality of stores along a delivery route, including store 200. As the delivery vehicle 112 arrives at store 200, the automated pallet sled 10 determines that the delivery vehicle 112 is at that store 200, either via GPS receiver 58, or directly from the server or from the driver's mobile device or via an API-connected route list. The processor 54 on the automated pallet sled 10 accesses the associated order 152 with the list of which pallets 116 are destined for the store 200. The processor 54 on the automated pallet sled 10 then finds those pallets 116 on the truck based upon a known sequence in which the delivery vehicle 112 was loaded (e.g. the pallets 116 for the first store should be nearest the liftgate 114) and based upon reading the RFID tags 117 on the pallets 116 with an RFID reader 70 on the automated pallet sled 10 (or NFC, barcode, QR code, or other unique identifiers).

The automated pallet sled 10 uses its sensors (e.g. rangefinder 46, camera 62, local navigation sensors 59, etc) to navigate within the storage area 119 of the delivery vehicle 112 and the liftgate 114 of the delivery vehicle 112.

The automated pallet sled 10 approaches different pallets 116 in the storage area 119 utilizing its suite of sensors (e.g. rangefinder 46, camera 62, etc) and reads their associated RFID tags 117. If the RFID tag 117 does not indicate that the pallet 116 is intended for the current store 200, then the automated pallet sled 10 does not select that pallet 116. However, the automated pallet sled 10 may move the pallet 116 out of the way.

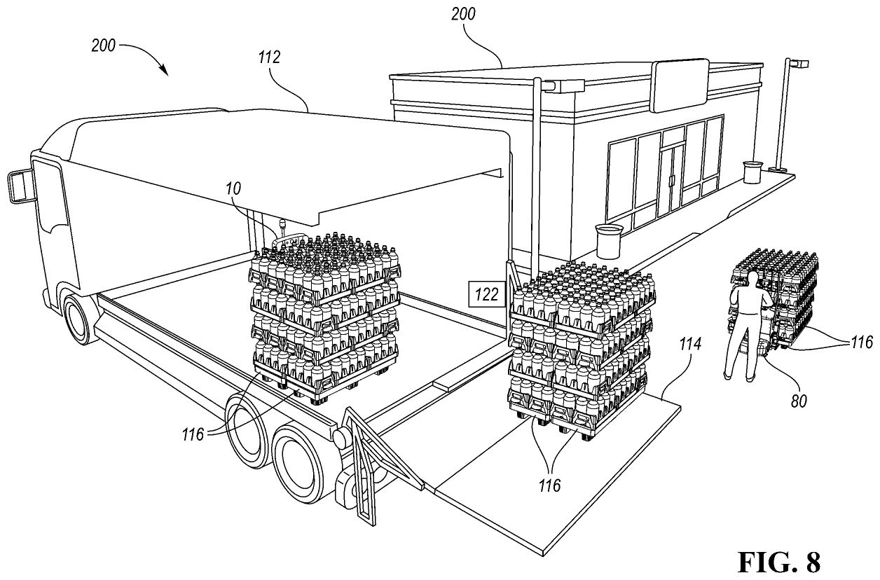

If the RFID tag 117 does indicate that the pallet 116 is intended for the current store 200, then the automated pallet sled 10 selects that pallet 116. As controlled by the processor 54, the automated pallet sled 10 approaches each pallet 116 destined for the store 200. The automated pallet sled 10 uses its rangefinder 46, camera 62 and any other sensors to position the tines 14 at the tine opening(s) of the pallet 116. The automated pallet sled 10 inserts the tines 14 under the pallet 116, lifts the pallet 116 and moves the pallet 116 onto the liftgate 114 as shown in FIG. 8. Then the automated pallet sled 10 retrieves the next pallet 116 destined for the store 200.

Referring to FIGS. 7 and 8, when a certain number of pallets 116 (e.g. two or four) are on the liftgate 114 (or one, if only one is intended for the store 200), the automated pallet sled 10 may send a wireless signal to the liftgate controller 122 to cause the liftgate 114 to lower to the ground. The driver then operates the manual pallet sled 80 to lift the pallets 116 and move them off the liftgate 114, two at a time, and move them into the store 200. The liftgate 114 is then raised so that the automated pallet sled 10 can retrieve more pallets 116 (if any) and place them on the liftgate 114 while the manual pallet sled 80 carries the pallets 116 into the store.

Alternatively, the driver selects the first two pallets 116 with the manual pallet sled 80, drives onto the liftgate 114, lowers the liftgate 114 to the ground, and then moves the first two pallets 116 to the store 200 while the automated pallet sled 10 starts retrieving additional pallets 116 intended for this store 200 and placing them on the liftgate 114.

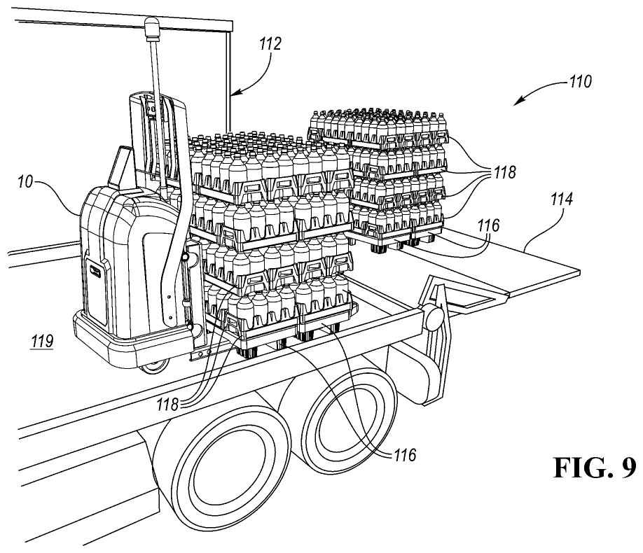

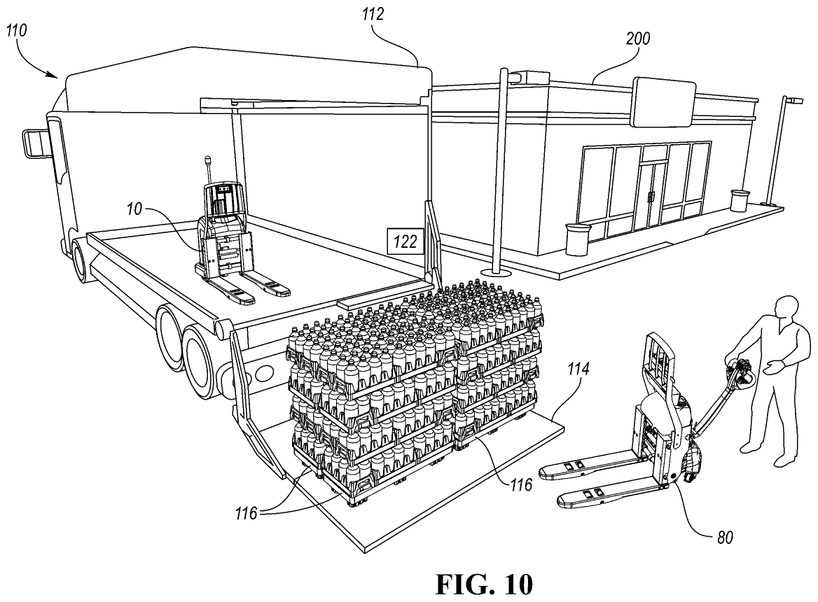

In FIG. 8, the automated pallet sled 10 (or the driver using manual pallet sled 80) loaded two pallets 116 onto the liftgate 114 and then lowered the liftgate 114. While the driver brought the first two pallets 116 to the store 200 on the manual pallet sled 80, the automated pallet sled 10 raised the liftgate 114 and loaded two more pallets 116 onto the liftgate 114. As shown in FIG. 9, the automated pallet sled 10 brings an additional two pallets 116 to the liftgate 114. As shown in FIG. 10, the automated pallet sled 10 will then cause the liftgate 114 to lower to the ground for retrieval by the driver.

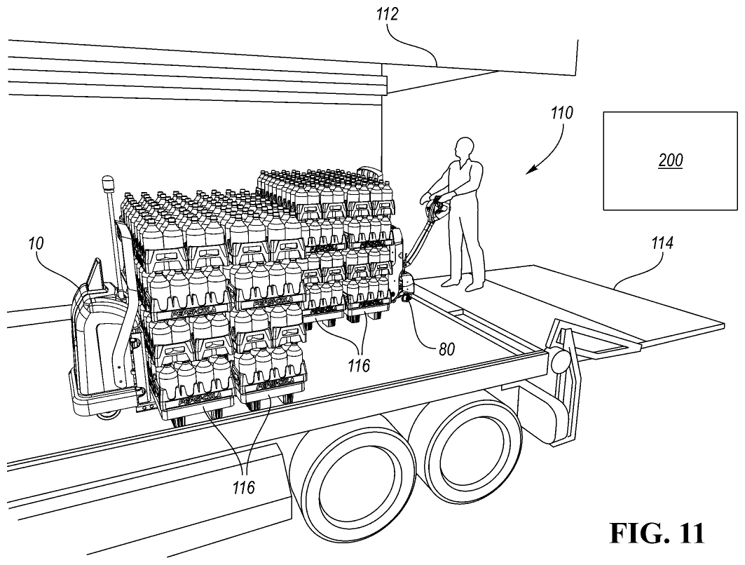

FIGS. 11 to 13 illustrate an alternative method of operation of the assisted delivery system 110. Referring to FIG. 11, upon arrival at the store 200, the driver uses the manual pallet sled 80 and the automated pallet sled 10 each select one or more pallets 116 (two, in the example shown) intended for the current store 200. Alternatively, the driver could control the automated pallet sled 10 to select and engage two pallets 116 for the current store 200.

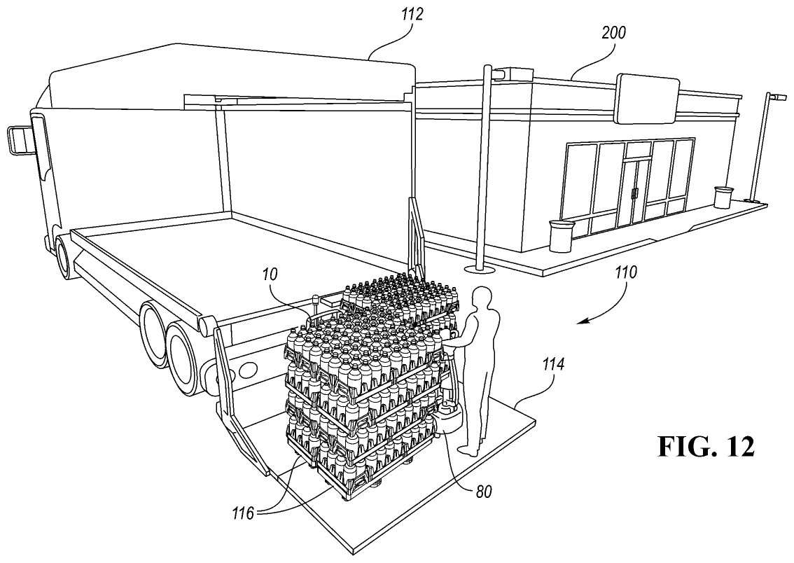

As shown in FIG. 12, the driver moves the manual pallet sled 80 and two pallets 116 onto the liftgate 114. The automated pallet sled 10 automatically drives onto the liftgate 114 with two pallets 116 as well. The liftgate 114 is then lowered by the driver to the ground.

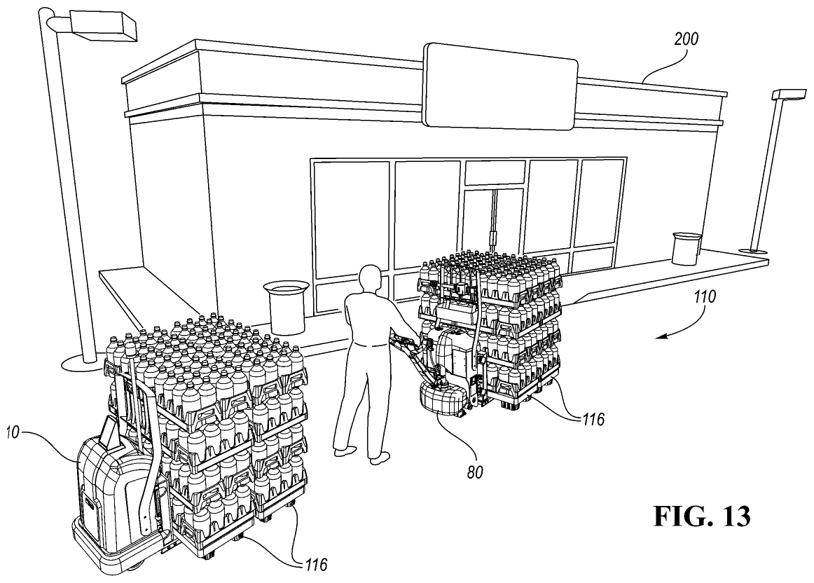

Referring to FIG. 13, the automated pallet sled 10 is placed in a “follow” mode in which the processor 54 controls movement of the automated pallet sled 10 by controlling the hub motors 34, 36 and steering motor 67 to cause the automated pallet sled 10 to follow the manual pallet sled 80 at a distance. The processor 54 tracks the position of the manual pallet sled 80 via rangefinder 46, camera 62, etc. The automated pallet sled 10 utilizes feature recognition as its main path generation tool while utilizing the suite of sensors (e.g. rangefinder 46, camera 62, etc) to monitor the environment to prevent accidents. For example, if it were to be following an individual (the driver), it could use the camera 62 (as processed by processor 54) to identify and follow the person or identify and follow a key feature such as a logo on their workwear. Another option would be to utilize a RF or Bluetooth keyfob carried by the driver and/or the manual pallet sled 80 as a positioning device to follow (utilizing wireless communication circuit 72).

The processor 54 maintains the automated pallet sled 10 at a safe distance behind the driver operating the manual pallet sled 80 and stops or avoids any obstacles, such as people, pets, potholes, vehicles, large debris, etc that it encounters along its path. This allows the driver to effectively double the number of pallets 116 being brought to the store.

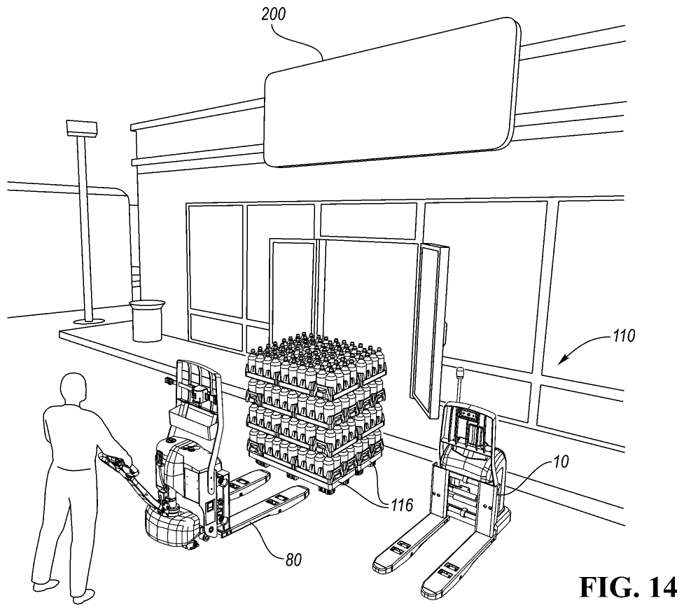

As one option, the automated pallet sled 10 may automatically stop outside the store 200 and deposit its pallets 116 on the ground outside the store 200 while the driver finishes delivery of the pallets 116 on the manual pallet sled 80 inside the store 200. Referring to FIG. 14, the driver then returns with the empty manual pallet sled 80, retrieves the pallets 116 brought by the automated pallet sled 10, and finishes delivery of those pallets 116 inside the store 200. The automated pallet sled 10 waits outside the store while the driver manually drives the manual pallet sled 80 into the store 200. After the driver completes delivery of the pallets 116 brought by the automated pallet sled 10, the automated pallet sled 10 follows the manual pallet sled 80 back to the delivery vehicle 112. Alternatively, the processor 54 can control the automated pallet sled 10 to return toward the delivery vehicle 112 while the driver is inside the store with the manual pallet sled 80.

The driver with the manual pallet sled 80 and the automated pallet sled 10 return to the delivery vehicle 112 and retrieve additional pallets 116 intended for this store 200, if any. When there are no more pallets 116 to deliver to this store 200, the manual pallet sled 80 and automated pallet sled 10 are returned to the storage area 119 of the delivery vehicle 112 and the delivery vehicle 112 proceeds to the next store where the process is repeated.

Full Automated Delivery

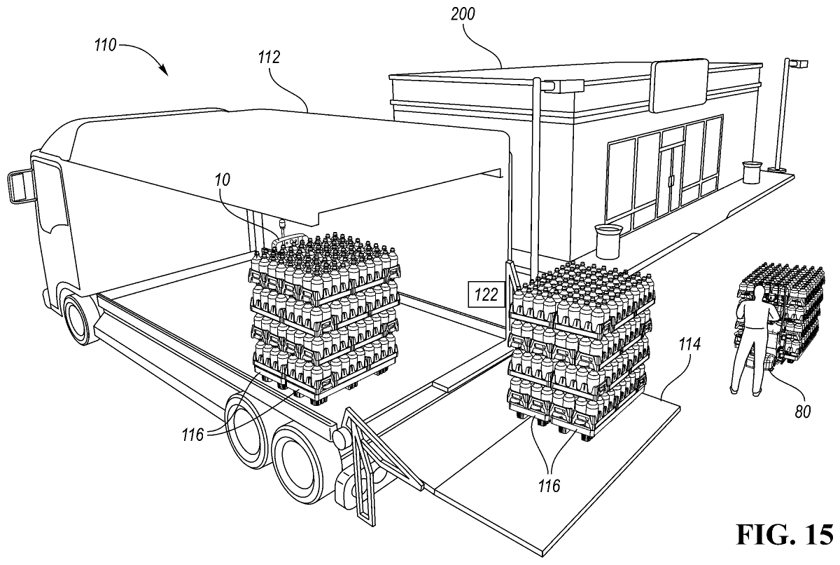

Referring to FIG. 15, the automated pallet sled 10 may be operated in a fully-automated mode. The automated pallet sled 10 will complete the same tasks as the driver without any intervention. The automated pallet sled 10 may retrieve pallets 116 and place them on the liftgate 114. The driver uses the manual pallet sled 80 to transport some of the pallets 116 from the delivery vehicle 112 to the store 200.

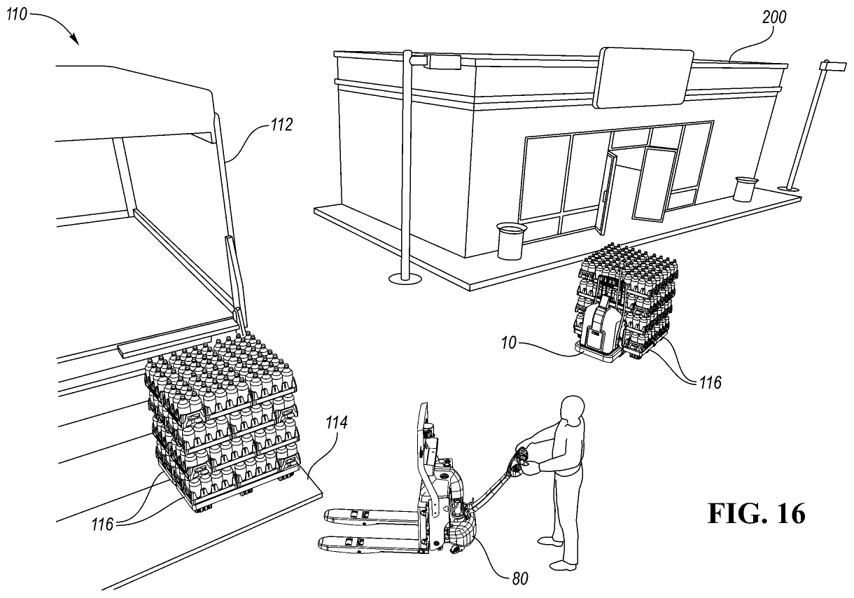

Referring to FIG. 16, at the same time, but operating independently, the automated pallet sled 10 transports some of the pallets 116 from the delivery vehicle 112 to the store 200 without any inputs from the driver. The automated pallet sled 10 will automatically react to the environment, including obstacles such as speed bumps, curbs or people to complete the delivery. The automated pallet sled 10 may bring the pallets 116 inside the store 200 to their ultimate destination. Alternatively, the driver delivers the first two pallets 116 inside the store 200 and the automated pallet sled 10 learns the destination location for its pallets 116 by following the manual pallet sled 80 on the first trip, but delivers additional pallets 116 on subsequent trips completely independently. Alternatively, if the assisted delivery system 110 has sufficient information, the automated pallet sled 10 can deliver all of the pallets 116 intended for that store 200 to the ultimate destination inside the store 200 automatically without human intervention. Alternatively, the automated pallet sled 10 may again leave the pallets 116 outside for the driver to bring inside with the manual pallet sled 80. The assisted delivery system 110 will have information regarding each store, including where to leave the pallets 116.

The automated pallet sled 10 may require minimal to no driver intervention to complete the delivery. This increases delivery efficiency so the driver can transport pallets in addition to focusing on check in with the customer.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope. Alphanumeric identifiers of operations or method steps are for ease of reference in dependent claims and do not signify a required sequence unless otherwise specifically indicated in the claims.

What is claimed is:

1. A delivery assist system for use inside a delivery vehicle comprising:
at least one support surface for supporting a pallet;
a plurality of wheels supporting the at least one support surface;
a motor configured to drive at least one of the plurality of wheels;
at least one processor;
a non-transitory computer readable medium storing instructions which when executed by the at least one processor cause the delivery assist system to:
a) locate a first pallet on the delivery vehicle;
b) lift the first pallet on the at least one support surface; and
c) move the first pallet on the at least one support surface within the delivery vehicle.

2. The delivery assist system of claim 1 wherein the instructions, when executed by the at least one processor cause the delivery assist system to, prior to operation a):
d) receive a current location; and
e) based upon the current location, determine that the first pallet should be delivered.

3. The delivery assist system of claim 2 further including an rfid reader, wherein the instructions, when executed by the at least one processor cause the delivery assist system to:
f) prior to operation c) read an rfid tag on the first pallet with the rfid reader.

4. The delivery assist system of claim 3 wherein the instructions, when executed by the at least one processor cause the delivery assist system to:
g) prior to operation f), read an rfid on a second pallet with the rfid reader; and
h) prior to operation f), based upon the current location, determine that the second pallet should not be delivered.

5. The delivery assist system of claim 4 further including a gps receiver for determining the current location, wherein the current location is received in operation d) from the gps receiver.

6. The delivery assist system of claim 1 wherein operation c) includes move the first pallet onto a lift gate of the delivery vehicle.

7. The delivery assist system of claim 6 wherein the instructions, when executed by the at least one processor cause the delivery assist system to cause the lift gate to move to a lowered position.

8. The delivery assist system of claim 1 further including a lift mechanism for raising the at least one support surface relative to the plurality of wheels.

9. The delivery assist system of claim 1 wherein the instructions, when executed by the at least one processor cause the delivery assist system to:
d) receive a current location;
e) read an rfid tag on each of a first plurality of pallets including the first pallet;
f) based upon the current location and the rfid tags, determine that the first plurality of pallets should be delivered at the current location; and
g) based upon operation f), perform operations a) through c) on each of the first plurality of pallets.

10. A delivery assist system comprising:
at least one support surface for supporting a pallet;
a plurality of wheels supporting the at least one support surface;
a motor configured to drive at least one of the plurality of wheels;
at least one processor;
a non-transitory computer readable medium storing instructions which when executed by the at least one processor cause the delivery assist system to:
a) raise a pallet on the at least one support surface;
b) follow a primary delivery sled from a delivery vehicle to a delivery destination; and
c) lower the pallet onto a floor or ground at the delivery destination.

11. The delivery assist system of claim 10 wherein the delivery destination is outside of a store.

12. The delivery assist system of claim 10 further including a camera, wherein operation b) includes use the camera to follow the primary delivery sled.

13. A delivery assist system comprising:
at least one support surface for supporting a pallet;
a plurality of wheels supporting the at least one support surface;
a motor configured to drive at least one of the plurality of wheels;
at least one processor;
a non-transitory computer readable medium storing instructions which when executed by the at least one processor cause the delivery assist system to:
a) place a pallet from a delivery vehicle onto the at least one support surface; and
b) move the pallet on the at least one support surface from the delivery vehicle to a delivery destination.

14. The delivery assist system of claim 13 wherein the delivery destination is outside a door of a store.

15. The delivery assist system of claim 13 wherein the delivery destination is inside a store.

16. The delivery assist system of claim 13 wherein the instructions, when executed by the at least one processor cause the delivery assist system to:
c) deliver the pallet to the delivery destination;
d) return to the delivery vehicle without the pallet; and
e) repeat operations a) through d) for each of a plurality of pallets.

17. The delivery assist system of claim 13 wherein operation a) further includes: lift the pallet from a liftgate of the delivery vehicle.

18. A computer-implemented method for assisting deliveries comprising:
a) locating a first pallet among a plurality of pallets on a delivery vehicle;
b) receiving a current location;
c) determining that the first pallet should be delivered at the current location; and
d) moving the first pallet via a computer controlling an automated pallet sled to a liftgate of the delivery vehicle.

19. The computer-implemented method of claim 18 further including:
e) prior to step d), lifting the first pallet on at least one support surface of the automated pallet sled; and
f) during step d), controlling at least one motor driving the automated pallet sled.

20. A computer-implemented method for assisting deliveries comprising:
a) lifting a first pallet on a support surfaced of an automated pallet sled; and
b) at least one processor on the automated pallet sled controlling the automated pallet sled to follow a primary pallet sled from a delivery vehicle to a delivery destination.
